(19) United States
(12) Patent Application Publication
(10) Pub. No.: US 2014/0263650 A1
(43) Pub. Date: Sep. 18, 2014

(54) Retro-reflective aircraft icing detection and notification

(71) Applicant: John Laurence Berman, Lyle, WA (US)

(72) Inventor: John Laurence Berman, Lyle, WA (US)

(21) Appl. No.: 13/999,775

(22) Filed: Mar. 18, 2014

Related U.S. Application Data
(60) Provisional application No. 61/852,306, filed on Mar. 15, 2013.

(51) Int. Cl. G06K 7/14

(52) U.S. Cl. CPC G06K 7/14
USPC 235/454

(57) ABSTRACT

A method and system to enable a laser scanner to scan specially-located segments of retro-reflective tape. The tape segments are adhered to an external aircraft surface such as the underside of a high-wing aircraft or the upper-side of a low-wing aircraft. The tape segments can be located in patterns similar to or identical to linear, matrix, or composite barcode patterns, such that they are readily decoded by processing means tailored for such decoding. The special locations of the tape segments take into account the angle between the normal to the surface and the line of sight from the scanner to the tape segments, as well as the distances from the scanner to the tape segments, such that the tape segments present to the scanner a decodable pattern. The pattern processing means can issue notifications that correspond to particular icing conditions. Edge detection target tape segments add additional capabilities.

### CROSS REFERENCED TO RELATED APPLICATION

I claim the benefit of U.S. provisional patent 61/852,306 filed on Mar. 15, 2013, entitled “Retro-reflective aircraft icing detection and notification,” which is incorporated herein by reference in its entirety.

### BACKGROUND OF THE INVENTION

The present invention relates generally to aircraft icing detection systems such as those disclosed, for example, in US patent application 20120085868 by W. Barnes (“Aircraft icing detector”). More particularly, various examples of the present invention provide a method and system for a user to receive a definitive indication of potentially-hazardous ice accretion on aircraft surfaces. More particularly still, the system can be implemented on an aircraft without a major alteration or, arguably, even a minor alteration as defined for example in Federal Aviation Administration (FAA) Advisory Circular 120-77, which provides that a minor alteration is an alteration which, if improperly done, would appreciably affect airworthiness. Moreover, neither proper nor improper installation of the disclosed invention should affect airworthiness. The resulting low installation cost of the system can make the system especially attractive. Retro-reflectivity is that provided by a corner cube reflector or a glass sphere reflector, where a light ray entering the cubical or spherical reflector exits in the opposite direction. The disclosed embodiment of the present invention utilizes silver 3M ScotchLite brand retro-reflective tape, adhered to an aircraft wing surface. Other embodiments, such as suspending micro glass spheres in paint that is painted onto any aircraft surface whose icing status is of interest, can be implemented without departing from the spirit and scope of the present invention

In contrast with the above-mentioned Barnes patent, the approach of the present invention, that of taping or painting retro-reflective areas on an external aircraft surface, obviates the need for “mounting a laser probe on a first surface of an airfoil,” or a system with “a first laser probe mounted on a first surface of an airfoil,” as stated in the Barnes patent. The mounting of any large apparatus such as that described by Barnes—large compared with the relevant length scales in the energy cascade for turbulent flow—necessarily disrupts the airfoil's aerodynamic characteristics. Such a mounting necessarily requires a major alteration of an aircraft. An implementation of the Barnes patent creates the problem that electrical cabling must pass through the airframe, which requires inspection, maintenance, and repair, which the present invention does not require. In accordance with the present invention, this problem is avoided.

### SUMMARY OF THE INVENTION

In accordance with the present invention, various examples of a method and system for retro-reflective aircraft icing detection and notification are provided. In accordance with various examples, a method and system to enable a laser scanner (“Scanner”), to scan specially-located segments of retro-reflective tape (“Tape Segments”), said Tape Segments adhered to an external aircraft surface (“Surface”), such as the underside of a high-wing aircraft or the upper-side of a low-wing aircraft. The Tape Segments can be located in patterns similar to or identical to linear, matrix, or composite barcode patterns, such that they are readily decoded by processing means tailored for such decoding. The special locations of the Tape Segments take into account the angle between the normal to the Surface and the line of sight from the Scanner to the Tape Segments, as well as the distances from the Scanner to the Tape Segments, such that the Tape Segments present to the Scanner a decodable pattern. The pattern processing means can issue notifications that correspond to particular icing conditions.

Alternatively, the Tape Segments do not have to be located in patterns similar to or identical to linear, matrix, or composite barcode patterns. The Tape Segments do not have to be located in patterns at all. An individual tape segment can be used as edge detection target (“Edge Target”). When the Scanner's laser beam transitions from the Tape Segment to off the Tape Segment or vice versa, a signal edge transition occurs at the electrical output of the optical detector that detects the presence of optical energy from the laser beam. The location, size, orientation, and spatial reflectivity gradient of an Edge Target can be optimized to achieve a particular signal edge transition rate. A signal edge transition rate is the rate of change of the electrical signal generated by the detector. For a fixed sweep rate, the rate of change of the electrical signal generated by the detector can be slowed down by creating a spatial reflectivity gradient on a Tape Segment. The spatial reflectivity gradient can be made by degrading the reflectivity of a Tape Segment along the direction of the sweep of the laser beam.

The process of optimizing the location, size, orientation, and spatial reflectivity gradient of an Edge Target can be theoretically determined or heuristically determined, or a combination of theoretical and heuristic determinations. In some cases, a fast signal edge transition rate may not be desirable. A fast signal edge transition rate is more sensitive to ice accretion than is a gradual edge transition characteristic. However, a fast signal edge transition rate is more susceptible to false alarms than a slower signal edge transition rate. Tape Segments of various sizes, various orientations, various spatial reflectivity gradients, at various locations can be scanned by the laser beam at various times to generate a data array of signal edge transitions rates. The data array of signal edge transition rates can be monitored by a computer that uses an analysis application program to determine whether ice accretion may be compromising flight performance. The analysis application program may recognize various states of ice accretion and report compromised flight performance of different levels of priority.

### BRIEF DESCRIPTION OF THE DRAWINGS

The various examples of the present invention will be described in conjunction with the accompanying figures to facilitate an understanding of the present invention. In the drawing:

FIG. 1 is a diagram of a high-wing aircraft, a Scanner is located in the cockpit (1). The Scanner transmits laser beam scans along a line of sight (3) which terminates, for example, on the underside of the wing (5). A matrix or other arrangement of Tape Segments (4) is located on the underside of the wing.

FIG. 2 is an example of a particular barcode that was formed with Tape Segments, placed approximately three feet from the wing root, such that the Scanner had a high-incidence line of sight to the Tape Segments, said incidence large with respect to the parallel to the Surface.

### DETAILED DESCRIPTION OF EXAMPLE EMBODIMENTS

Referring to the Figures, one example of a Scanner is a handheld barcode scanner such as the Intermec SR61T barcode scanner (“SR61T”). The SR61T can transfer barcode data, linear, matrix, or composite barcode images to a host computer over a USB 2.0 bus. The SR61T-XR version of the scanner incorporates an extra long-range imaging area, and is specified by the manufacturer to read barcode data, linear, matrix, or composite barcode images from over 50 feet away from the images. The actual performance of any scanner depends on parameters describing the imaging being scanned, its distance from the scanner, angle of incidence, ambient lighting, among others. The host computer, so connected to an SR61T, can perform advanced processing of images if necessary. One example of said Tape Segments can be derived from cutting a 2″×36″ roll of silver 3M ScotchLite brand retro-reflective tape into Tape Segments. The dimensions of the Tape Segments cut from the roll are tailored according to the line of sight and distance relationships, as described above.

The invention has been tested on a high-wing aircraft, with matrix pattern images made from Tape Segments adhered to the underside of the wing, said patterns placed at several distances, as measured longitudinally in the direction of the wing spar, from a Scanner that was either handheld or mounted internal to the aircraft cockpit. As the patterns were placed further toward the wing tip, the lower resulting angle of incidence necessitated larger Tape Segments and larger spacing between Tape Segments, in order to create a pattern decodable by the Scanner and associated processing means. Oscillation of the wings caused movement of the Tape Segment patterns, but such movement was generally within the capability of the Scanner to capture useful data.

Also, as patterns were placed further toward the wing tip, the increased specular reflection from ambient daylight into the Scanner's line of sight at the lower incidence to the Surface of the Scanner's line of sight, degraded the system's ability to decode the patterns. This ambient daylight degradation was more pronounced with the sun on the same side of the aircraft as the Tape Segments, not surprisingly. Mounting Tape Segments on both sides of the aircraft gets around the above-mentioned sun-side degradation. The absence of daylight at night eliminated said degradation, needless to say.

Testing was done in the southern Cascade and Trinity Alps region near the Oregon-California border, known among local aviators as “ice alley.” Even in the absence of NOAA-designated icing conditions in the region, the region often contains clouds in which aircraft icing can occur, interspersed with clear and open alleys in between the clouds. Under such conditions, relatively safe exits from icing conditions are available. On an instrument flight plan in weather conditions not designated as icing conditions, an aircraft can legally enter and exit clouds in which some ice accretion may inadvertently occur. Under such conditions, testing of the disclosed system revealed that for clear ice, a degradation of the Scanner's imaging of the Tape Segments occurs prior to the pilot's visual confirmation of the clear ice. The clear ice was visually characterized by the pilot as trace ice. Trace ice forward of wing or stablizer control surfaces is not typically a concern; however, catastrophic events have been documented where control surfaces bind due to ice.

A particular advantage of the present invention is the ability to adhere the Tape Segments in various locations on a Surface, where some of the Tape Segment locations can be close to ailerons, for example. The Scanner transmits Tape Segment image data to the host computer, in addition to digital barcode data, and the host computer can perform image analysis on the received data. Of particular note is a sharp signal edge where the Scanner's laser beam transitions from the Tape Segment to off the Tape Segment or vice versa. These signal edge transitions are particularly sensitive to ice accretion, and can be characterized through image processing edge detection techniques well known in the art. The disclosed system used these signal edge transition changes, among other signal characteristics, to initiate early warnings of ice accretion. Other standard methods of characterizing imagery are well known in the art and can be sued to initiate early warnings of ice accretion. Other standard methods of characterizing time for an optical scanning system to achieve recognition can be used to initiate early warnings of ice accretion.

While the foregoing description has been with reference to particular examples of the present invention, it will be appreciated by those skilled in the art that changes in these examples may be made without departing from the principles and spirit of the invention. Accordingly, the scope of the present invention can only be ascertained with reference to the appended claims.

What is claimed is:

1. An optical scanning means to direct optical energy from a first station on an airframe of an aircraft.
